(19) United States
(12) Patent Application Publication
(10) Pub. No.: US 2009/0126548 A1
(43) Pub. Date: May 21, 2009

(54) Punch press

(75) Inventors: Tadashi Uozumi, Kyoto (JP); Hiroichi Sakamoto, Aichi (JP)

Correspondence Address: WENDEROTH, LIND & PONACK, L.L.P., 1030 15th Street, N.W.,, Suite 400 East, Washington, DC, 20005-1503, US

(73) Assignee: Murata Machinery, Ltd.

(21) Appl. No.: 12/292,087

(22) Filed: Nov. 12, 2008

(30) Foreign Application Priority Data
Nov. 16, 2007 (JP) 2007-298168

(51) Int. Cl. B21D 28/36; B30B 1/14

(52) U.S. Cl. 83/669; 100/272

(57) ABSTRACT

To provide a punch press which can effectively suppress vibration even when punching operation is performed at high speed. The punch press according to the present invention includes a press drive source, a drive transmitting mechanism which transmits power from the press drive source to a punch tool, and the punch tool connected to the drive transmitting mechanism, wherein at least a part of the drive transmitting mechanism is made of a carbon fiber material. Accordingly, the weight of the drive transmitting mechanism is reduced, and thus it is possible to reduce the force of inertia generated by the mass transfer of the drive transmitting mechanism and effectively suppress vibration, even when punching operation is performed at high-speed. When the power transmitting mechanism is made lighter in such manner, there is the effect of reducing the noise during the punching operation and reducing the power consumed during the punching operation.

### BACKGROUND OF THE INVENTION

(1) Field of the Invention

The present invention relates to a punch press which makes holes, and the like, on a plate material, and particularly to a technique for effectively suppressing vibration even when punching operation is performed at high speed.

(2) Description of the Related Art

A punch press is known as a machine tool for making holes, and the like, on a plate material.

FIGS. 10 through 12 are explanatory diagrams for a conventional punch press. As shown in FIG. 10, the side-view of a press frame 1 is in the shape of the letter C. An upper turret 2 and a lower turret 3 are provided, on the same axis, on an upper frame part 1a and a lower frame part 1b, respectively. The upper turret 2 and the lower turret 3 have plural punch tools 4 and die tools 5, respectively, which are circumferentially arranged. The upper turret 2 and the lower turret 3 are indexed, via a chain mechanism, using an index motor 30 provided in a throat part 1c of the press frame 1. When indexed to a punch position (ram position) P, each punch tool 4 is driven up and down by a ram 6.

At the same time, as shown in FIG. 11 and FIG. 12, a plate material W set on a work table 18 is clamped by work holders 17 of a work transfer mechanism 20 and transferred up to the punch position P, after which the plate material W is aligned with the desired punch position P and machined by the punch tools (not shown) (see Patent Reference 1: Japanese Patent No. 3467868).

Now, since a large load is applied to a power transmitting mechanism during the above-described punching operation, it is common to use a member that is made of steel (and cast metal) material for the power transmitting mechanism. Therefore, there is a problem that, in the case where a heavy member made of steel material and the like is used for the power transmission mechanism unit, vibration is generated in the punch press due to the force of inertia generated by the movement of the power transmitting mechanism, and it is difficult to suppress vibration that is generated particularly when the punching operation is performed at high speed. Such problem regarding vibration suppression becomes more prominent with the advance of high-speed punching operation.

### SUMMARY OF THE INVENTION

The present invention is conceived in order to solve the aforementioned problem and has as an object to provide a punch press which can effectively suppress vibration even when punching operation is performed at high speed.

In order to achieve the aforementioned object, the punch press according to the present invention includes: a press drive source; a drive transmitting mechanism which transmits power from the press drive source to a punch tool; and the punch tool connected to the drive transmitting mechanism, wherein at least a part of the drive transmitting mechanism is made of a carbon fiber material. With this, the weight of the drive transmitting mechanism can be reduced, and thus it is possible to reduce the force of inertia generated by the movement of the drive transmitting mechanism and effectively suppress vibration, even when punching operation is performed at high-speed. In the case where the power transmitting mechanism is made lighter in such manner, there is the effect of reducing the noise generated by the punch press during the punching operation, and furthermore, there is the effect of reducing the power consumed by the punch press during the punching operation.

Here, the part made of the carbon fiber material may be one of members having highest percentage contribution to vibration suppression, among members included in the drive transmitting mechanism. Accordingly, since a member that is made of carbon fiber material is generally costly compared to a member that is made of a steel material, it is possible to use the costly carbon fiber material for only a member having a high percentage contribution to vibration suppression and, by not using the costly carbon fiber material for members having low percentage contribution to vibration suppression, an unnecessary increase in the cost of the punch press can be avoided.

Furthermore, the drive transmitting mechanism may include a hollow-centered rod, and the rod may be made of the carbon fiber material. Accordingly, since carbon fiber material is used in a simple structural member such as the hollow-centered rod, manufacturing becomes easy and mass production becomes possible. Furthermore, since the rod is formed with a hollow center, the mass of the rod can be reduced.

Furthermore, both ends of the rod may be bonded to a metal member by using an adhesive. With this, both ends of the rod and the respective metal members can be easily bonded.

Furthermore, the rod may have a layered structure made of the carbon fiber material, and the carbon fiber material may be wrapped in a circumferential direction in at least one layer of the layered structure. By wrapping carbon fiber material in an axial direction for the remaining majority of the layers, it becomes possible to withstand a large load on the axial direction.

Furthermore, the rod may be part of an arm which is directly connected to a crank attached to the press drive source. With this, it becomes possible to use the carbon fiber material for the member which transmits the rotation of the crank.

Furthermore, the part made of the carbon fiber material may be a member extending between a power-amplifying mechanism and a crank attached to the press drive source. With this, it becomes possible to use the carbon fiber material for the member which extends between the crank and the power amplifying mechanism.

As is clear from the description above, the punch press in the present invention allows the weight of the drive transmitting mechanism to be reduced, and thus it is possible to reduce the force of inertia generated by the mass transfer of the drive transmitting mechanism and effectively suppress vibration, even when the punching operation is performed at high-speed. In the case where the power transmitting mechanism is made lighter in such manner, there is the effect of reducing the noise during the punching operation as well as reducing the power consumed during the punching operation. In addition, since it is possible not to use the costly carbon fiber material for members having a low percentage contribution to vibration suppression, it is possible to prevent an unnecessary increase in the cost of the punch press. Furthermore, since carbon fiber material can be used in a simple structural member such as the hollow-centered rod, manufacturing becomes easy and suitable for mass production.

### FURTHER INFORMATION ABOUT TECHNICAL BACKGROUND TO THIS APPLICATION

The disclosure of Japanese Patent Application No. 2007-298168 filed on Nov. 16, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an example of a punch press in the present invention;

FIG. 2 is an explanatory diagram for the operating principle of a power transmitting mechanism in the present invention;

FIG. 3 is a diagram showing an example of a one-piece arm in the present invention;

FIGS. 4A and 4B are diagrams showing an example of the bonding of a rod and metal members in the present invention;

FIGS. 5A through 5D are diagrams showing an example of a method for forming the rod in the present invention;

FIG. 6 is a diagram showing an example of a cross-section of the rod in the present invention;

FIG. 7 is a diagram schematically depicting main units of the punch press in the present invention;

FIG. 8 is a diagram showing an example of the percent contribution to vibration suppression in the present invention;

FIGS. 9A and 9B are diagrams showing an example of the bonding of a rod and metal members in the present invention.

FIG. 10 is an explanatory diagram for the punch press disclosed in Patent Reference 1;

FIG. 11 is an explanatory diagram for the punch press disclosed in Patent Reference 1;

FIG. 12 is an explanatory diagram for the punch press disclosed in Patent Reference 1;

### DESCRIPTION OF THE PREFERRED EMBODIMENT(S)

Hereinafter, an embodiment of the present invention shall be described with reference to the Drawings.

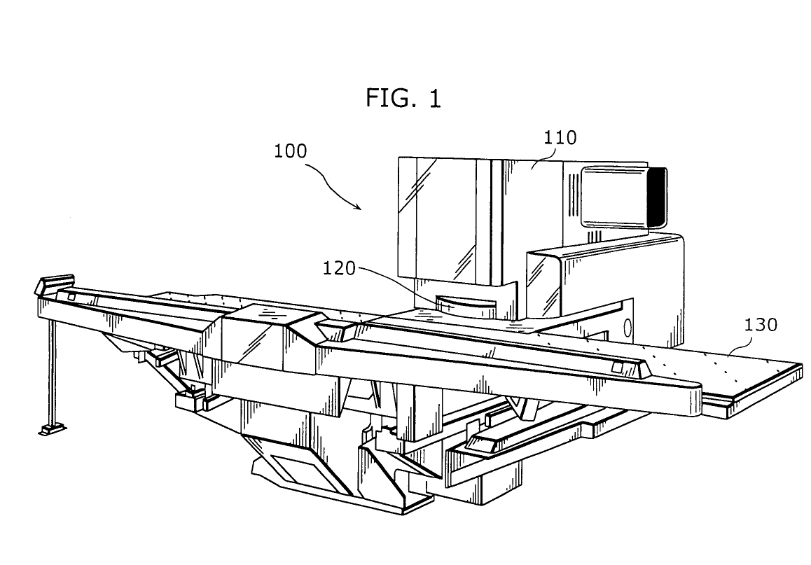

FIG. 1 is a diagram showing an example of a punch press 100 in the present invention.

As shown in the figure, the punch press 100 includes a so-called C-type, open-front press frame 110. Upper and lower turrets 120 which support plural tools are placed in spaces in the upper and lower frame parts of the press frame 110. The upper and lower turrets 120 have plural punch tools and die tools, respectively, which are arranged in a circumferential direction. A power transmission mechanism unit described later is provided in the upper frame unit, and a specific position in the forward part of the turret 120 serves as the punch position at which the plate material punching operation is performed. Specifically, the plate material that is set on a work table 130 is held and transferred up to the punch position by a work transfer mechanism, then aligned with the desired punch position, and machined using the punch tools.

It should be noted that although the so-called C-type press frame 110 is exemplified, the press frame 110 is not limited to such type. For example, a so-called portal-type press frame 110 may also be used.

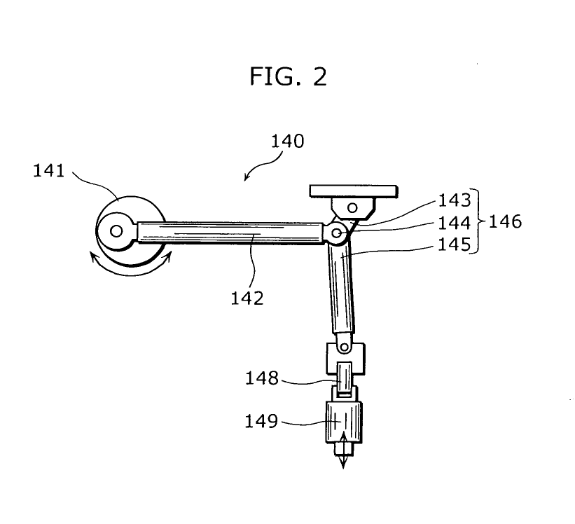

FIG. 2 is an explanatory diagram for the operating principle of a power transmitting mechanism 140.

As shown in the figure, the power transmitting mechanism 140 includes a press drive source (not shown) such as a servomotor, a crank 141, an arm 142, a toggle mechanism 146, a ram 148, and a punch holder 149. The toggle mechanism 146 includes an upper toggle link 143, a pin 144, and a lower toggle link 145. Although the punch tools (not shown) are fastened to the punch holder 149, the punch tools are not included in the power transmitting mechanism 140.

In such a structure, first, when the servomotor causes the crank 141 to rotate once, the arm 142 makes one reciprocation of a forward and backward operation. During the period in which the arm 142 reaches a central position in the forward-backward stroke from a left-end position, within this one reciprocal operation, the toggle mechanism 146 changes from a leftward flexed state to a stretched state, whereby the ram 148 falls from a top dead center to a bottom dead center. On the other hand, during the period in which the arm 142 reaches a right-end position from the central position in the forward-backward stroke, the toggle mechanism 146 changes from the stretched state to a rightward flexed state, whereby the ram 148 rises from the bottom dead center to the top dead center. The ram 148 also rises and falls in the same manner as described above when the arm 142 returns from the right-end position to the left-end position.

In this manner, the arm 142 makes one reciprocation of the forward and backward operation while the crank 141 makes one rotation. With this, the ram 148 rises and falls twice, and the punching operation by the punch tools fastened to the punch holder 149 is performed twice. With such a power transmitting mechanism 140, the power of the servomotor can be amplified and converted to a powerful punching force, using the toggle mechanism 146 which is a power amplifying mechanism, and energy consumption can be suppressed.

Now, since a large load is applied during the punching operation, conventionally, it is common to use a member that is made of a steel material for the power transmitting mechanism 140. However, in the case where a member made of steel material is used, there is a problem that, when the punching operation is performed at high-speed, it is difficult to suppress vibration generated due to the force of inertia generated by the power transmitting mechanism 140's own mass transfer. Consequently, in order to solve such vibration suppression problem, the present invention adopts the technique described hereafter.

Specifically, the present invention is characterized in making at least a part of the power transmitting mechanism 140 using a carbon fiber material such as CFRP. CFRP (Carbon Fiber Reinforced Plastic) is plastic reinforced with carbon fiber, and is highly elastic and light. Therefore, by constructing at least a part of the power transmitting mechanism 140 using CFRP, the power transmitting mechanism 140 can be made lighter, and thus it is possible to reduce the force of inertia generated by the mass transfer of the power transmitting mechanism 140 and effectively suppress vibration, even when the punching operation is performed at high-speed. When the power transmitting mechanism 140 is made lighter in such manner, there is the effect of reducing the noise during the punching operation as well as reducing the power consumed during the punching operation.

Hereinafter, the usage of CFRP shall be described in further detail.

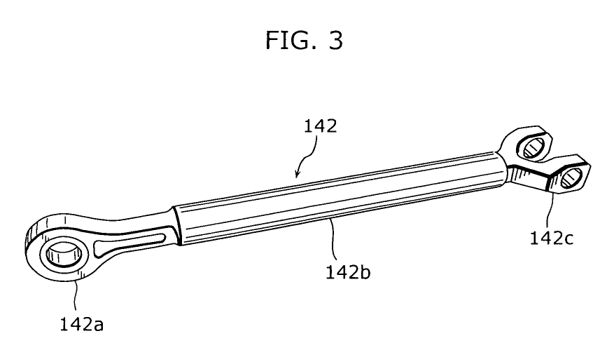

FIG. 3 is a diagram showing an example of the arm 142.

As shown in the figure, the arm 142 is configured of two metal members 142a and 142c, and one rod 142b. The metal members 142a and 142c are members made of steel (and cast metal) material. One end of the metal member 142a is bonded to the rod 142b, and the other end is linked to the crank 141. The other end of the metal member 142a is not limited to any particular shape, and any shape may be adopted as long as it is suitable for linking with the crank 141. Furthermore, one end of the metal member 142c is bonded to the rod 142b, and the other end is linked to the toggle mechanism 146. The other end of the metal member 142c is not limited to any particular shape, and any shape may be adopted as long as it is suitable for linking with the toggle mechanism 146.

The rod 142b is a member made of CFRP, and extends from the crank 141 up to the toggle mechanism 146, via the metal members 142a and 142c. With this, when the servomotor rotates the crank 141, the arm 142 performs one reciprocation of the forward and backward operation, and thus rotating motion is converted to linear motion.

Although the size of the rod 142b is determined in relation to the other members, it is assumed to be approximately 1.2 meters in the present embodiment. When such a rod 142b is made of CFRP, the mass of the whole arm 142 becomes approximately 16 kilograms. When the rod 142b is made of steel material, the mass of the whole arm 142 is approximately 30 kilograms, and thus the present invention allows the mass of the whole arm 142 to be reduced to nearly half of what is conventional.

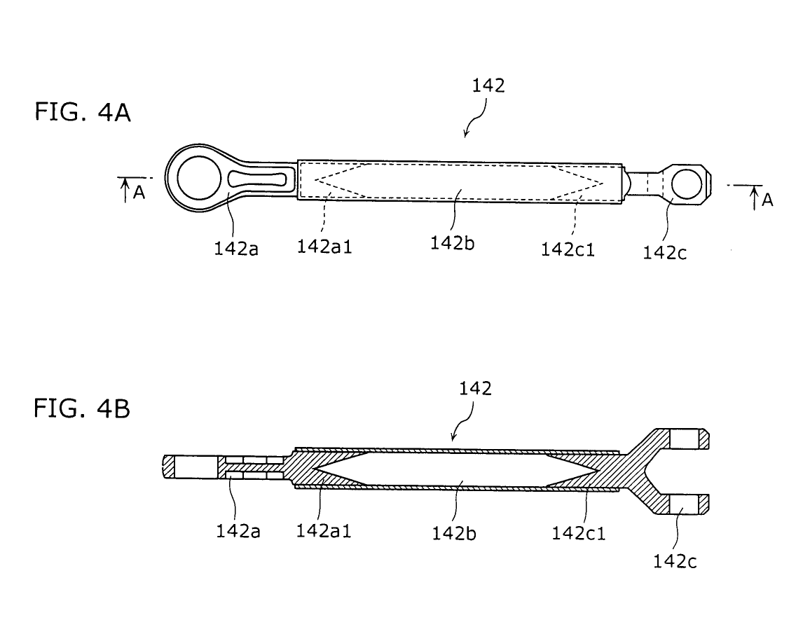

FIGS. 4A and 4B are diagrams showing an example of the bonding of the rod 142b and the metal members 142a and 142c.

FIG. 4B is a cross sectional view taken along line A-A in FIG. 4A. The rod 142b is formed, for example, in the shape of a cylinder using a technique described later. Furthermore, the inner peripheral surface of the one end of the metal members 142a and 142c are formed so as to be tapered. An adhesive such as epoxy is applied onto the outer surface of such tapered portions 142a1 and 142c1 and the tapered portions 142a1 and 142c1 are inserted and bonded to the rod 142b. By tapering the one end of the metal members 142a and 142c, the mass of the metal members 142a and 142c can be reduced.

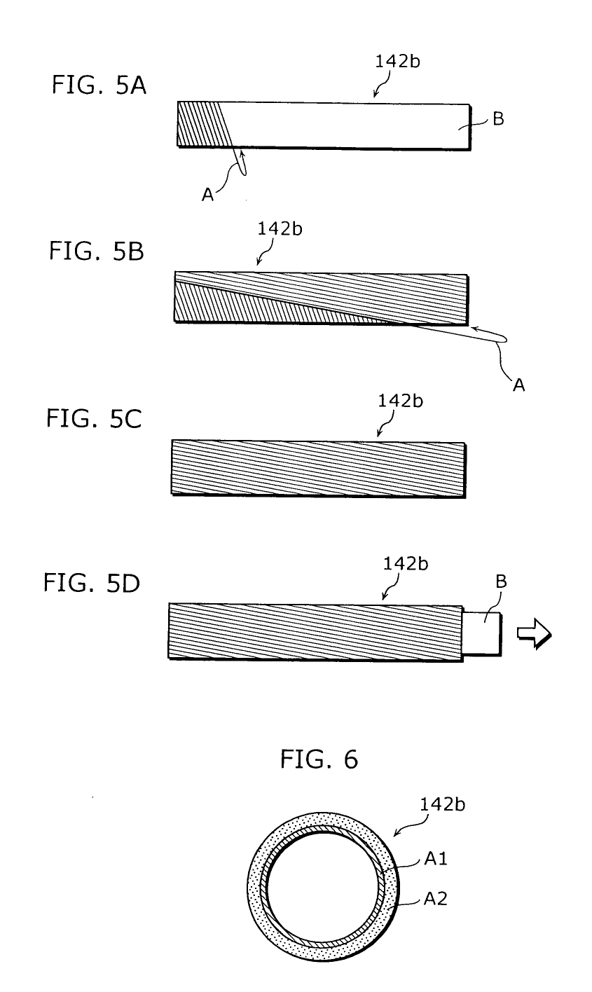

FIGS. 5A through 5D are diagrams showing an example of the technique for forming the rod 142b.

First, as shown in FIG. 5A, carbon fiber material A is wrapped around, for example, a cylindrical or columnar core B. With one process, one layer wrapped with the carbon fiber material A is formed. For a certain layer, the carbon fiber material A is wrapped in a circumferential direction. Circumferential direction refers to a direction which is between 45 and 90 degrees inclusive, where the axial direction with respect to the core B is 0 degrees and the circumferential direction with respect to the core B is 90 degrees.

For another layer, the carbon fiber material A is wrapped in an axial direction, as shown in FIG. 5B. Axial direction refers to a direction which is not less than 0 degrees but less than 45 degrees, where the axial direction with respect to the core B is 0 degrees and the circumferential direction with respect to the core B is 90 degrees.

In this manner, plural layers are formed by wrapping the carbon fiber material A in the circumferential direction or the axial direction, on top of a previous wrapped layer of the carbon fiber material A, as shown in FIG. 5C.

Lastly, the core B is drawn out, as shown in FIG. 5D.

Thus, the layered rod 142b is formed according to the above-described technique.

FIG. 6 is a diagram showing an example of the cross-section of the rod 142b.

As shown in the figure, the rod 142b includes at least two kinds of layers, namely, a layer A1 in which the carbon fiber material is wrapped in the circumferential direction, and a layer A2 in which the carbon fiber material is wrapped in the axial direction. The thickness of the layer A2 in which the carbon fiber material is wrapped in the axial direction is equal to or greater than a predetermined percentage of the thickness of the total layers.

It should be noted that although a cylindrical rod 142b is exemplified here, the shape of the rod 142b is not particularly limited to such. More specifically, the form of the rod 142b need not be cylindrical (hollow-centered). Obviously, when formed with a hollow center, the mass of the rod 142b can be reduced. Furthermore, the cross-sectional shape of the rod 142b need not be round. For example, by forming the cross-sectional shape as an ellipse or oval instead of a perfect circle, the rod can be strengthened against bending by aligning the long axis direction of the ellipse to the direction in which the rod is most susceptible to force.

Now, from the point of view of reducing the weight of the punch press, it is preferable that, aside from the rod 142b, the metal members 142a and 142c, the toggle mechanism 146, and in addition the ram 148, and so on, are also made of CFRP. However, CFRP is costly, and thus, from a cost standpoint, it is not practical to construct every member from CFRP. Consequently, the present invention adopts the following technique.

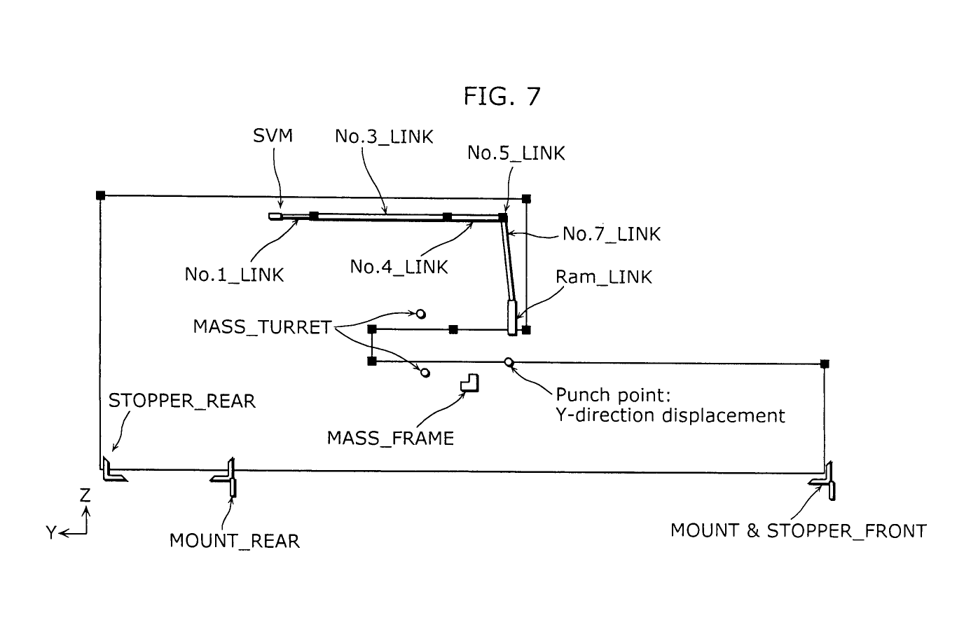

FIG. 7 is a diagram schematically depicting the main units of the punch press 100 in the present invention.

Here, the punch press 100 is shown from a side-view perspective. “SVM” in the figure corresponds to the servomotor. “No. 1_LINK” corresponds to the metal member 142a. “No. 3_LINK” and “No. 4_LINK” correspond to the rod 142b. “No. 5_LINK” corresponds to the metal member 142c. “No. 7_LINK” corresponds to the toggle mechanism 146. “Ram_LINK” corresponds to the ram 148. In the present invention, focus is placed on the fact that the percent contribution to vibration suppression is different according to these points.

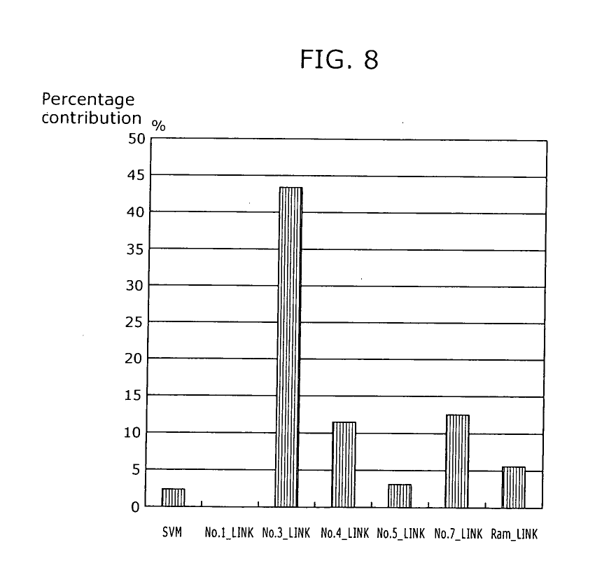

FIG. 8 is a diagram showing an example of percentage contribution to vibration suppression.

As shown in the figure, for example, when the “No. 3_LINK” and the “No. 4_LINK” have a high percentage contribution, the costly carbon fiber material may be used for only the rod 142b which corresponds to the “No. 3_LINK” and the “No. 4_LINK”. In this manner, the costly carbon fiber material is not used for members having a low percentage contribution to vibration suppression, and thus it is possible to prevent an unnecessary increase in the cost of the punch press.

As is clear from the description above, the punch press in the present invention allows the weight of the drive transmitting mechanism to be reduced, and thus it is possible to reduce the force of inertia generated by the mass transfer of the drive transmitting mechanism and effectively suppress vibration, even when the punching operation is performed at high-speed. In the case where the power transmitting mechanism is made lighter in such manner, there is the effect of reducing the noise during the punching operation as well as reducing the power consumed during punching. In addition, since it is possible not to use the costly carbon fiber material for members having a low percentage contribution to vibration suppression, it is possible to prevent an unnecessary increase in the cost of the punch press. Furthermore, since carbon fiber material can be used in a simple structural member such as the hollow-centered rod, manufacturing becomes easy and suitable for mass production.

It should be noted that although a one-piece arm 142 is exemplified in the description above, the present invention is not limited to such construction. More specifically, the fabrication of the rod 142b can be simplified by adopting the one-piece arm 142, thus making it suitable for mass production. However, when only the achievement of the object of suppressing vibration is considered, other configurations for the arm 142 may be adopted as long as the weight of the arm 142 is reduced. For example, even when a three-piece arm 142 is adopted, the object of suppressing vibration can be achieved by using CFRP for such arm 142.

Furthermore, although a servomotor is exemplified as the press drive source in the description above, the present invention is not limited to such. For example, the same effect can be obtained even when a hydraulic cylinder or linear motor is adopted as the press drive source. It is also effective to have the reciprocal motion units, such as the hydraulic cylinder, made out of CFRP.

Furthermore, although the description above states that the punch press 100 performs machining of plate material, the shape and the material of the work piece is not particularly limited to such.

Furthermore, although a configuration including the toggle mechanism 146 is exemplified in the description above, the present invention is not limited by whether or not the toggle mechanism 146 is included. Specifically, as long as at least a part of the power transmitting mechanism 140 is made using a carbon fiber material, even when the rest of the parts include different parts, it is intended to be included in the scope of the present invention.

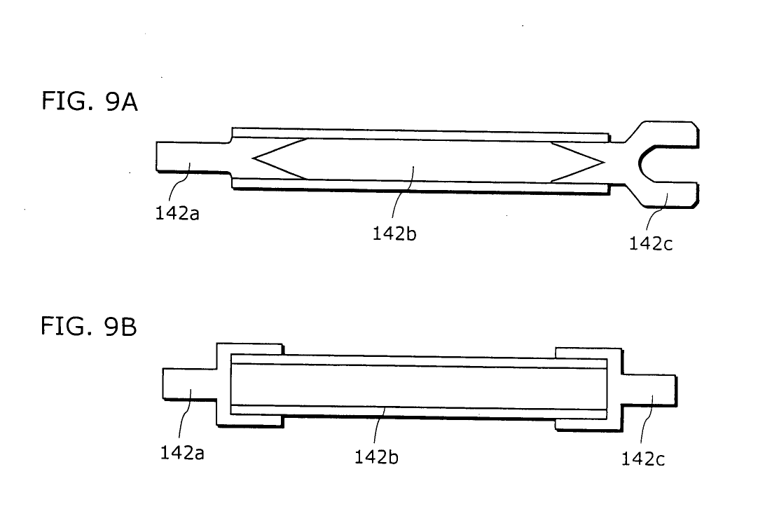

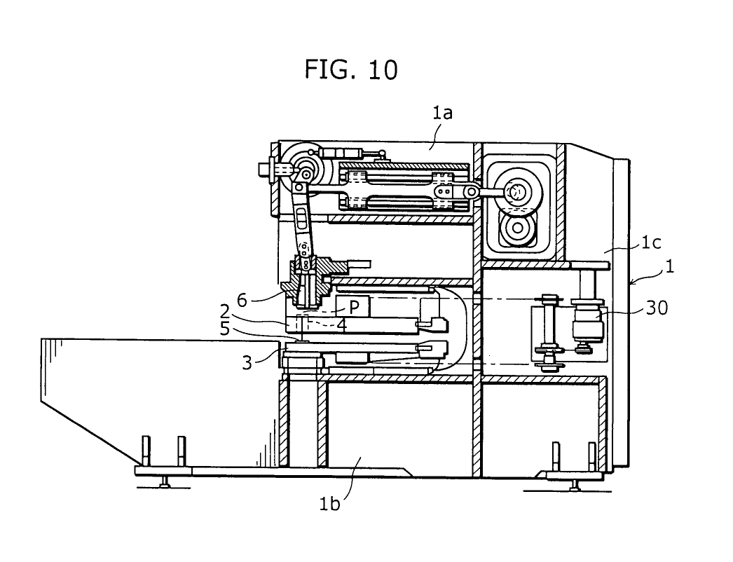

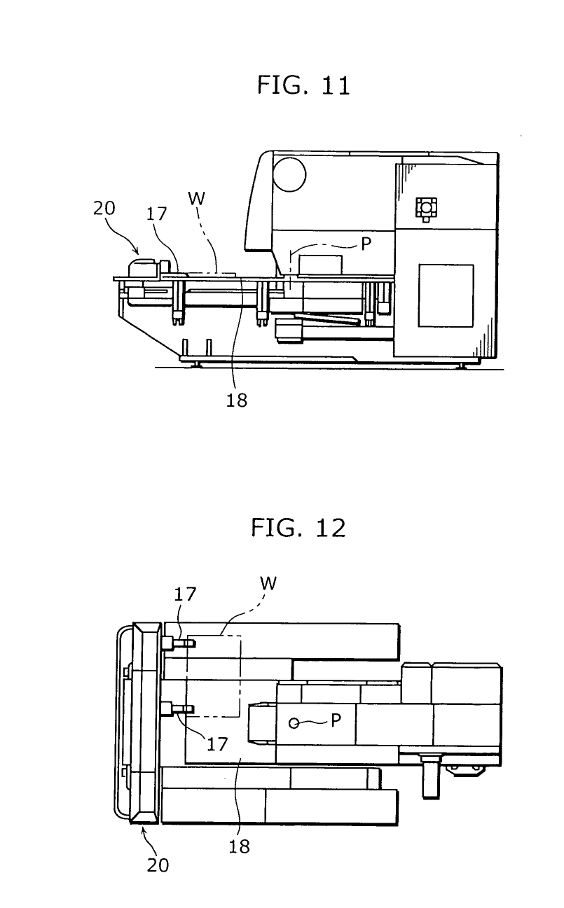

Furthermore, although a configuration in which the metal members 142a and 142c are inserted in the rod 142b is exemplified in the description above, the present invention is not limited to such. Specifically, instead of inserting the metal members 142a and 142c in the rod 142b as shown in FIG. 9A, the metal members 142a and 142c may sandwich the rod 142b as shown in FIG. 9B.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention can be applied for use in a punch press requiring effective suppression of vibration even when punching operation is performed at high-speed.

What is claimed is:

1. A punch press comprising:
a press drive source;
a drive transmitting mechanism which transmits power from said press drive source to a punch tool; and
said punch tool connected to said drive transmitting mechanism,
wherein at least a part of said drive transmitting mechanism is made of a carbon fiber material.

2. The punch press according to claim 1,
wherein, the part made of the carbon fiber material is one of members having highest percentage contribution to vibration suppression, among members included in said drive transmitting mechanism.

3. The punch press according to claim 1,
wherein said drive transmitting mechanism includes a hollow-centered rod, and
said rod is made of the carbon fiber material.

4. The punch press according to claim 3,
wherein both ends of said rod are bonded to a metal member by using an adhesive.

5. The punch press according to claim 3,
wherein said rod has a layered structure made of the carbon fiber material, and
the carbon fiber material is wrapped in a circumferential direction in at least one layer of the layered structure.

6. The punch press according to claim 3,
wherein said rod is part of an arm which is directly connected to a crank attached to said press drive source.

7. The punch press according to claim 1,
wherein the part made of the carbon fiber material is a member extending between a power-amplifying mechanism and a crank attached to said press drive source.
